(19) United States
(12) Patent Application Publication
(10) Pub. No.: US 2018/0060569 A1
(43) Pub. Date: Mar. 1, 2018

(54) Detection and Prevention of Malicious Shell Exploits

(71) Applicant: QUALCOMM Incorporated, San Diego, CA (US)

(72) Inventors: Minjang Kim, San Jose, CA (US); Dong Li, Cupertino, CA (US); Sudha Anil Kumar Gathala, Tracy, CA (US)

(21) Appl. No.: 15/249,110

(22) Filed: Aug. 26, 2016

(51) Int. Cl. G06F 21/55; G06F 21/52

(52) U.S. Cl. CPC G06F 21/55; G06F 21/52

(57) ABSTRACT

Methods, systems, and devices detect and block execution of malicious shell commands requested by a software application. Various embodiments may include receiving a request from a software application to execute a shell command and simulating execution of the shell command to produce execution behavior information. The computing device may analyze system activities to produce execution context information and generate an execution behavior vector based, at least in part, on the execution behavior information and the execution context information. The computing device may use a behavior classifier model to determine whether the shell command is malicious. In response to determining that the shell command is malicious, the computing device may block execution of the shell command.

### BACKGROUND

Cellular and wireless communication technologies have seen explosive growth over the past several years. Wireless service providers now offer a wide array of features and services that provide their users with unprecedented levels of access to information, resources and communications. To keep pace with these enhancements, consumer electronic devices (e.g., cellular phones, watches, headphones, remote controls, etc.) have become more powerful and complex than ever, and now commonly include powerful processors, large memories, and other resources that allow for executing complex and powerful software applications on their devices. These devices also enable their users to download and execute a variety of software applications from application download services (e.g., Apple® App Store, Windows® Store, Google® play, etc.) or the Internet.

Due to these and other improvements, an increasing number of mobile and wireless device users now use their devices to store sensitive information (e.g., credit card information, contacts, etc.) and/or to accomplish tasks for which security is important. For example, computing device users frequently use their devices to purchase goods, send and receive sensitive communications, pay bills, manage bank accounts, and conduct other sensitive transactions. Due to these trends, computing devices are becoming the next frontier for malware and cyber attacks. Accordingly, new and improved security solutions that better protect resource-constrained computing devices, such as mobile and wireless devices, will be beneficial to consumers.

### SUMMARY

Various implementations may include methods, devices for implementing the methods, and non-transitory processor-readable storage media including instructions configured to cause a processor to execute operations of the methods for detecting malicious behavior in shell command execution. Various implementations may include receiving, by a processor of the computing device, a request from a software application to execute a shell command on the computing device, simulating execution of the shell command to produce execution behavior information, analyzing system activities to produce execution context information, generating an execution behavior vector based, at least in part, on the execution behavior information and the execution context information, using a behavior classifier model to determine whether the shell command is malicious, and blocking execution of the shell command in response to determining that the shell command is malicious.

In some implementations, selecting the behavior classifier model based, at least in part, on the execution behavior vector may include selecting a command specific classifier model. In such implementations, selecting the behavior classifier model may include selecting a command specific classifier model. In such embodiments, selecting the behavior classifier model may include identifying execution characteristics of the simulated shell command execution, and selecting the behavior classifier model to include the identified characteristics.

In some implementations, simulating execution of the shell command to produce execution behavior information may include predicting an execution path of the shell command, and analyzing behaviors of the predicted execution path to identify the execution behavior information. In such implementations, predicting the execution path of the shell command may include generating a parse data structure. In such implementations, analyzing the behaviors of the predicted execution path to identify the execution behavior information may include characterizing patterns of commands executed within the predicted execution path. In such implementations, analyzing the behaviors of the predicted execution path to identify the execution behavior information may include identifying data leaks resulting from commands executed within the predicted execution path.

In some implementations, analyzing system activities may include analyzing a number of preceding shell commands.

In some implementations, analyzing system activities may include analyzing application program interface calls.

In some implementations, analyzing system activities may include determining whether the shell command is a sink command.

In some implementations, analyzing system activities may include determining a shell environment.

Further implementations may include a communications device having one or more processors configured with processor-executable instructions to perform operations of the methods summarized above. Further embodiments may include a communications device having means for performing functions of the methods summarized above. Further embodiments may include a non-transitory processor-readable storage medium on which is stored processor-executable instructions configured to cause a processor of a communication device to perform operations of the methods summarized above.

### BRIEF DESCRIPTION OF THE DRAWINGS

The accompanying drawings, which are incorporated herein and constitute part of this specification, illustrate exemplary embodiment of the claims, and together with the general description given above and the detailed description given below, serve to explain the features of the claims.

FIG. 1 is a component block diagram of an example system on chip suitable for implementing the various embodiments.

FIG. 2 is a block diagram illustrating logical components and information flows in an example computing device configured to use machine learning techniques to determine whether to execute a shell command accordance with the various embodiments.

FIG. 3A is a block diagram illustrating a shell command execution path of a computing device configured to determine the execution context in which the shell command may execute on the device.

FIG. 3B is a block diagram illustrating a graphical analysis of shell command execution path of a computing device configured to determine the execution context in which the shell command may execute on the device.

FIG. 4 is a process flow diagram illustrating a method of detecting malicious shell commands using machine learning to analyze execution context of an executing software application in order to determine whether a computing device behavior is malignant or benign.

FIG. 5 is a component block diagram of an example computing device suitable for use with the various embodiments.

FIG. 6 is a component block diagram of an example server computer suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Tracking the impact of shell command execution throughout a software execution session is important for both malware detection and privacy protection. During the execution of software applications on computing devices, programmatic or logic errors can render the application vulnerable to exploitation by malware or malicious actors. The effects of malicious or corrupted shell commands throughout execution of the software application may result in operating system malfunction, data leakage, or data loss as a result of such exploitations.

By predicting the impact of shell command execution on the operating system throughout the execution of a software application, it is possible to preemptively identify points of system malfunction or information corruption. Thus, proper emulation of shell command impacts throughout execution of a software application should be part of efforts to reduce instances of operating system functional degradation and data loss, and protect a user's computing device from compromise by malware applications, surreptitious shell commands, and malicious actors.

In overview, various embodiments include methods, and computing devices configured to perform the methods, of detecting and blocking execution of malicious shell commands requested by a software application or process in a computing device. Various embodiments may include receiving, by a processor of the computing device, a request from a software application (or process) to execute a shell command on the computing device, such as by attempting to execute “runtime.exec” on a computing device. Various embodiments may further include executing a simulation or emulation of executing the shell command to produce execution behavior information, and characterizing the predicted shell command execution (e.g., additional shell commands call, potential for recursive activity, etc.) based on the execution behavior information. The processor of the computing device may analyze system activities (e.g., API calls, shell environment, previously executed shell commands, etc.) to produce execution context information. Various embodiments may include generating an execution behavior vector based, at least in part, on the execution behavior information and the execution context information, selecting a behavior classifier model based, at least in part, on the execution behavior vector, and using the selected behavior classifier model to determine whether the shell command is malicious. Various embodiments may include blocking execution of the shell command in response to determining that the shell command is malicious.

The terms “computing device” and “mobile computing device” are used generically herein to refer to any one or all of servers, personal computers, and mobile electronic devices, such as cellular telephones, smartphones, tablet computers, laptop computers, netbooks, ultrabooks, palm-top computers, personal data assistants (PDA's), wireless electronic mail receivers, multimedia Internet enabled cellular telephones, Global Positioning System (GPS) receivers, wireless gaming controllers, and similar personal electronic devices that include a programmable processor. While the various embodiments are particularly useful in mobile computing devices, such as smartphones, which have limited processing power and battery life, the embodiments are generally useful in any computing device that includes a programmable processor.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software foil controlling the integrated resources and processors, as well as for controlling peripheral devices.

The term “context” is used herein to refer to any information available to a process or thread running in a host operating system (e.g., Android, Windows 8, LINIX, etc.). Context may include operational state data and permissions and/or access restrictions that identify resources that the software application may access, as well as state information of the operating environment. Examples of context include operating system services, libraries, file systems, shell command execution history, shell environment, the duration and frequency of user interactions with a software application, sensor input access by the software application, API calls, whether the software application auto-launched, peripheral devices engaged, and communications received and/or sent.

As used herein the terms “operating system shell” or “shell” are used to denote a specialized application that uses an operating system's kernel application program interface (API) to manage user-system interaction. The shell may prompt users for input, interpret that input, and manage resulting operating system output. Thus, the shell does not provide users with direct access to operating system functionality, but interpret user requests of the operating system.

User instructions to the operating system shell are input in the form of “shellcode” or “bytecode”. Using shellcode programming techniques, a user can instruct the shell as to how the user would like to access or manipulate operating system services such as file system management, batch management, process (i.e., software application) management, as well as operating system configuration. For example, a specific shell command, or set of shell commands may instruct the shell to configure one or more open communications ports. Such services are required by software applications that rely upon network data transactions. However, if executed by unauthorized applications, such shell commands may enable malicious actors to gain access to the computing device via the opened communications port.

Various implementations may enable a computing device to detect the malicious nature of a shell command by simulating shell command execution and analyzing a result, based at least in part, on execution context within which the shell command might execute. By performing the simulation and analysis prior to actual execution of shell commands, the computing device may identify suspicious or performance degrading shell commands and block or otherwise prevent their execution. Blocking the execution of suspicious or performance degrading shell commands may provide increased security to the computing device by reducing the opportunities for malicious actors to access the computing device, subvert device functions, or steal user data. Further, by blocking the execution of suspicious or performance degrading shell commands, the computing device may improve performance and battery life by reducing the occurrences of recursively spawning processes that tie up processing resources and exhaust battery power.

In an implementation, the computing device may be equipped with an execution simulation module that is configured to simulate, emulate, or otherwise predict the results of executing a shell command. The shell command may be one requested for execution by a software application running on the computing device. The execution simulation module may generate a predicative execution path graph for the requested shell command. A predicative execution path graph may include subsequent shell command executions. In various implementations, the execution simulation module may analyze the predictive execution path graph to identify patterns of intractable command execution (e.g., limitless recursion), data leaks, and other performance degrading behaviors. Any performance degrading or suspicious behaviors identified by the execution simulation module may be collected and stored as execution behavior information.

In an implementation, the computing device may be equipped with an execution context inference module that is configured to receive shell command execution behavior information, event, and/or behavior information from various software and hardware components of the computing device. Such information may include any or all of operating state information, execution history (e.g., the previous “N” shell commands executed), upcoming executions (e.g., shell commands queued for execution), shell environment, execution event information, information from sensors indicating activity/inactivity, CPU/GPU usage levels, battery consumption levels, information identifying an implemented functionality, resource state information, memory transaction information, communication transaction information, and other types of information related to the various behaviors, activities, operations, and events ongoing in the computing device that are related to the execution of the shell command requested by the software application.

Determining the execution context of an executing software application based, at least in part, on observed behaviors occurring during or just prior to the simulated execution of the shell command may be useful to systems and methods that monitor computing device behavior to identify performance degrading problems and malware. Generally, the performance and power efficiency of a computing device degrade over time.

The various embodiments for detecting malicious shell commands may be used by comprehensive behavioral monitoring and analysis systems for intelligently and efficiently identifying, preventing, and/or correcting the execution of performance degrading shell commands that promote conditions, factors, and/or computing device behaviors that may degrade a computing device's performance and/or power utilization levels over time. In such behavioral monitoring and analysis systems, an observer process, daemon, module, or sub-system (herein collectively referred to as a “module”) of the computing device may instrument or coordinate various application programming interfaces (APIs), registers, counters or other components (herein collectively “instrumented components”) at various levels of the computing device system.

The observer module may continuously (or near continuously) monitor computing device behaviors by collecting behavior information from the instrumented component. The computing device may also include an analyzer module, and the observer module may communicate (e.g., via a memory write operation, function call, etc.) the collected behavior information to the analyzer module.

The execution context inference module and execution simulation module may provide the collected shell command behaviors and execution context to a behavior extractor module. The behavior extractor module may use the collected information in machine learning techniques to generate execution context vectors representing the various events and circumstances associated with the simulated execution of the shell command requested by a software application.

The analyzer module may be configured to perform real-time behavior analysis operations. Such real-time behavior analysis operations may include performing, executing, and/or applying data, algorithms, classifiers or models (herein collectively referred to as “classifier models”) to the collected behavior information to determine whether a computing device behavior, particularly a shell command attempting to execute, is benign or not benign (e.g., malicious or performance-degrading). The computing device may use the results of this analysis to heal, cure, isolate, or otherwise fix or respond to identified problems.

In various implementations, the analyzer module may be configured to use the execution context information to select a classifier model that focuses on the features most relevant to analyzing a specific shell command or behavior. Selecting a classifier model that focuses on the features most relevant to analyzing a specific shell command or behavior may enable the system to better determine the intent (malicious vs. benign) of the software application. Additionally or alternatively, selecting a classifier model that focuses on the features most relevant to analyzing a specific shell command or behavior may enable the system to better determine whether a computing device behavior, particularly a shell command attempting to execute, is performance-degrading or benign. Similarly, the observer module may be configured to use this information to better identify the features that require monitoring and/or to determine the granularity at which select features are to be monitored.

In various implementations, the observer and/or analyzer modules may be configured to use the execution context information to select an application-specific lean classifier model that includes a focused data model that includes/tests only the features/entries that are most relevant for determining whether that particular software application is benign or not benign (e.g., malicious or performance-degrading). Similarly, the analyzer module may select a “command-specific” classifier module that includes focused data associated with shall command execution. For the purposes of providing a clear and concise description of the various implementations, the term “application-specific” is used to reference both application and command specific classifier models.

Various implementations may include components configured to use an execution simulation module to predict shell command behavior prior to actual execution by an application. Various implementations may include components configured to perform behavioral analysis operations on the predict shell command behavior to determine an execution context of a shell command attempting to execute on a computing device.

Various implementations may include components configured to combine information obtained from a shell command execution emulation (i.e., execution behavior information) with execution context information to determine whether an undesired event will occur if the shell command is allowed to execute. That is, the components may be configured to use execution behavior information with execution context information to classify whether a potential operation is malicious, suspicious, or otherwise performance degrading.

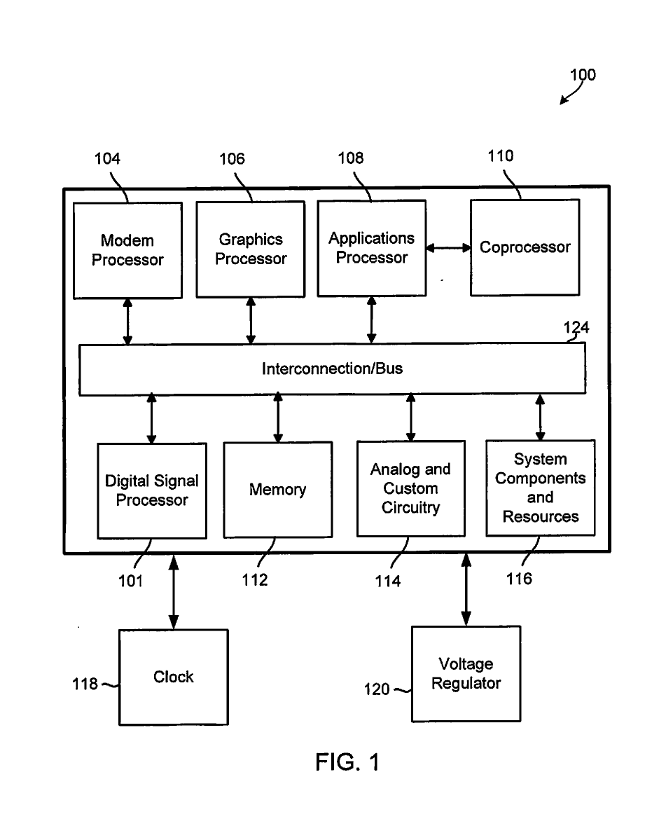

The various embodiments may be implemented in a number of different computing devices, including single processor and multiprocessor systems, and a system on chip (SOC). FIG. 1 illustrates an example SOC 100 architecture that may be used in computing devices implementing the various embodiments. The SOC 100 may include a number of heterogeneous processors, such as a digital signal processor (DSP) 101, a modem processor 104, a graphics processor 106, and an applications processor 108. The SOC 100 may also include one or more coprocessors 110 (e.g., vector co-processor) connected to one or more of the heterogeneous processors 101, 104, 106, 108. Each processor 101, 104, 106, 108, 110 may include one or more cores, and each processor/core may perform operations independent of the other processors/cores. For example, the SOC 100 may include a processor that executes a first type of operating system (e.g., FreeBSD, LINIX, OS X, etc.) and a processor that executes a second type of operating system (e.g., Microsoft Windows 8).

The SOC 100 may also include analog circuitry and custom circuitry 114 for managing sensor data, analog-to-digital conversions, wireless data transmissions, and for performing other specialized operations, such as processing encoded audio signals for games and movies. The SOC 100 may further include system components and resources 116, such as voltage regulators, oscillators, phase-locked loops, peripheral bridges, data controllers, memory controllers, system controllers, access ports, timers, and other similar components used to support the processors and clients running on a computing device.

The system components and resources 116 and custom circuitry 114 may include circuitry to interface with peripheral devices, such as cameras, electronic displays, wireless communication devices, external memory chips, etc. The processors 101, 104, 106, 108 may be interconnected to one or more memory elements 112, system components and resources 116 and analog and custom circuitry 114 via an interconnection/bus module 124, which may include an array of reconfigurable logic gates and/or implement a bus architecture (e.g., CoreConnect, AMBA, etc.). Communications may be provided by advanced interconnects, such as high performance networks on chip (NoCs).

The SOC 100 may further include an input/output module (not illustrated) for communicating with resources external to the SOC 100, such as a clock 118 and a voltage regulator 120. Resources external to the SOC 100 (e.g., clock 118, voltage regulator 120) may be shared by two or more of the internal SOC processor and processor cores (e.g., DSP 101, modem processor 104, graphics processor 106, applications processor 108, etc.).

The SOC 100 may also include hardware and/or software components suitable for collecting sensor data from sensors, including speakers, user interface elements (e.g., input buttons, touch screen display, etc.), microphone arrays, sensors for monitoring physical conditions (e.g., location, direction, motion, orientation, vibration, pressure, etc.), cameras, compasses, GPS receivers, communications circuitry (e.g., Bluetooth®, WLAN, WiFi, etc.), and other well known components (e.g., accelerometer, etc.) of modern electronic devices.

In addition to being implemented in an SOC 100 discussed above, the various implementations may be implemented in a wide variety of computing devices, which may include a single processor, multiple processors, multicore processors, or any combination thereof.

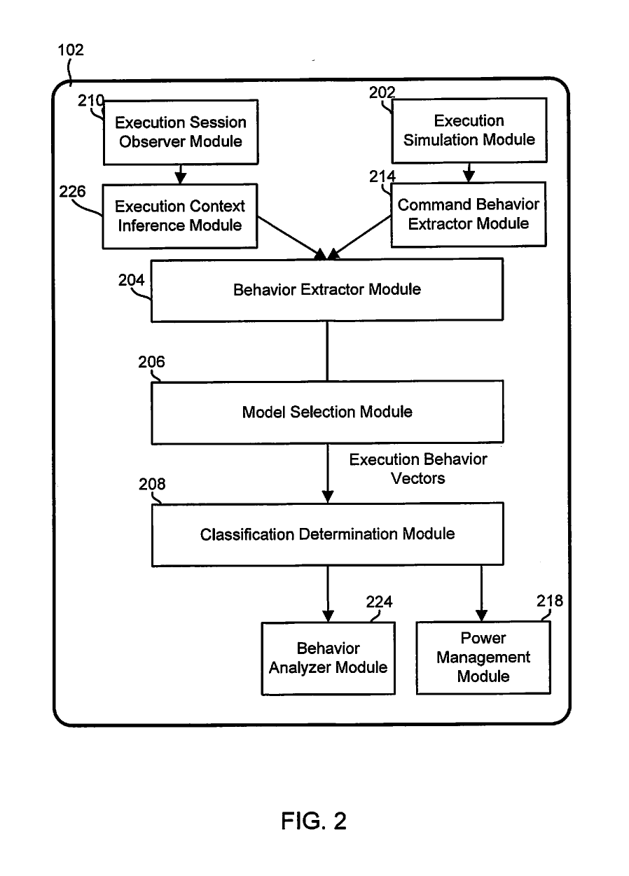

FIG. 2 illustrates example logical components and information flows in an implementation computing device 102 configured to use machine learning techniques to detect performance degrading shell commands by simulating execution of the shell command and determining an execution context of the shell command requested by a software application of the computing device. In the example illustrated in FIG. 2, the computing device 102 includes an execution simulation module 202, a command behavior extractor module, 214, an execution session observer module 210, an execution context inference module 226, an behavior extractor module 204, a model selection module 206, a classification determination module 208, a power management module 218, and a behavior analyzer module 224

Each of the modules 202-226 may be implemented in software, hardware, or any combination thereof. In various implementations, the modules 202-226 may be implemented within parts of the operating system (e.g., within the kernel, in the kernel space, in the user space, etc.), within separate programs or applications, in specialized hardware buffers or processors, or any combination thereof. In an implementation, one or more of the modules 202-226 may be implemented as software instructions executing on one or more processors of the computing device 102.

The execution simulation module 202 may be configured to monitor various software and hardware components of the computing device and receive requests for the execution of shell commands in association with the runtime operations of software applications. In various implementations, the execution simulation module 202 may be configured to execute a simulation of the shell command execution prior to actual execution of the shell command in order to predict a shell command execution path. The command behavior extractor module 214 may be configured to analyze the predicted shell command execution path to identify performance degrading characteristics (e.g., data leaks, recursive calls, and infinite loops).

The execution simulation module 202 may also be configured to continually monitor the computing device for changes in the computing device's configuration and/or execution context as a result of executing a shell command. The execution simulation module 202 may also monitor configuration and/or execution context changes that may impact the performance or effectiveness of the computing device. The execution simulation module 202 may store the collected information in a memory (e.g., in a log file, etc.) and/or send (e.g., via memory writes, function calls, etc.) the generated observations to execution context inference module 226 and the behavior extractor module 204.

The execution context inference module 226 may be configured to receive the output of the execution behavior information produced during the shell command execution simulation. The execution session observer module 210 may monitor, collect, and store information about system activities relevant to the simulated shell command execution. The execution context inference module 226 may use the information collected by the execution session observer module 210 and analyze this information to determine the context in which the shell command execution is simulated. That is, the execution context inference module 226 may analyze the system activities that impact, relate to, or result from the simulated shell command execution. The execution session observer module 210 may monitor system activities that include software application API calls made, current shell environment, the last “N” shell commands executed, a shell command execution queue, modification of execution state from foreground to background, accessing of sensors, low level system calls, user activity event information (e.g., a surface touch, click, button actuation, etc.), information from sensors indicating activity/inactivity, CPU/GPU usage levels, battery consumption levels, information identifying an implemented functionality, memory transaction information, communication transaction information, application status change events, user interface interactions, and other types of information related to the various activities and events ongoing in the computing device. These system activities may be analyzed using machine learning techniques to determine a context (e.g., execution context information) under which the simulated shell command execution occurred.

The application behavior extractor module 204 may be configured to generate one or more execution behavior vectors based, at least in part, on the execution behavior information and the execution context information. The execution context may be placed by the behavior extractor module 204 into a vector or matrix to form an execution behavior vector. In various implementations, the application behavior extractor module 204 may be configured to perform any or all of operations that may be performed by the behavior analyzer module 224 (discussed in detail further below) to extract the behavior associated with the shell command execution simulation and the execution context information. The behavior extractor module 204 may send the generated behavior vectors and/or the extracted behavior information the classification determination module 206 for further analysis.

The model selection module 206 may receive behavior vectors and compare them to one or more behavior models to determine whether the behavior of the shell command, if allowed to execute, would be malignant or benign based, at least in part, on the circumstances under which it is operating. In an implementation, these behavior models may be classifier models that include a plurality of test conditions suitable for evaluating or identifying the computing device features used by a specific shell command during and/or as a result of execution. The features used by the specific shell command or a specific shell command type may be determined by simulating the execution of a specific shell command and monitoring or evaluating computing device operations, computing device events, data network activity, system resource usage, computing device execution session context, inter-process communications, driver statistics, hardware component status, hardware counters, actions or operations of software applications, software downloads, changes to device or component settings, conditions and events at an application level, conditions and events at the radio level, conditions and events at the sensor level, location hardware, personal area network hardware, microphone hardware, speaker hardware, camera hardware, screen hardware, universal serial bus hardware, synchronization hardware, location hardware drivers, personal area network hardware drivers, near field communication hardware drivers, microphone hardware drivers, speaker hardware drivers, camera hardware drivers, gyroscope hardware drivers, browser supporting hardware drivers, battery hardware drivers, universal serial bus hardware drivers, storage hardware drivers, user interaction hardware drivers, synchronization hardware drivers, radio interface hardware drivers, and location hardware, near field communication (NFC) hardware, screen hardware, browser supporting hardware, storage hardware, accelerometer hardware, synchronization hardware, dual subscriber identity module (SIM) hardware, radio interface hardware, and features unrelated related to any specific hardware. The model selection module 206 may select an appropriate classifier model and pass the model, along with the extracted behavior information, to the classification determination module 208.

In an implementation, the classification determination module 208 may be configured to apply the classifier model selected by the model classification module 206 to the execution behavior vectors to infer, estimate, predict, or determine a classification (e.g., permissible/unauthorized, malignant/benign) for the simulated shell command execution based, at least in part, on the execution context information and the execution behavior information of the shell command. That is, the classification determination module 208 may generate malicious behavior detection information that is more accurate, detailed, and finer grained than the context-blind information provided by stock malware detection methods. In various implementations, the classification determination module 208 may be configured to perform any or all of operations that may be performed by the behavior analyzer module 224 to determine the execution context of the software application.

As mentioned above, each software application generally performs a number of shell command executions on the computing device, and the specific execution context in which certain shell commands execute in the computing device may be a strong indicator of whether the shell command execution merits additional or closer scrutiny, monitoring, analysis, and/or should be blocked. As such, in the various implementations, a processor of the computing device 102 may be configured with processor-executable instructions to use information identifying the execution contexts in which certain tasks/activities are performed to focus its behavioral monitoring and analysis operations and better determine whether a shell command execution is benign, suspicious, malicious, or performance-degrading.

In various implementations, the behavior analyzer module 224 may be configured to associate the shell command execution simulation information with the execution context in which those the shell command execution simulation was performed. For example, the observer module may be configured to generate an execution behavior vector that includes the behavior information collected from the execution simulation and from monitoring the instrumented components in a sub-vector or data-structure that lists the features, activities, or operations of the software for which the execution context is relevant (e.g., location access, simple message service (SMS) read operations, sensor access, etc.). In an implementation, this sub-vector/data-structure may be stored in association with a shadow feature value sub-vector/data-structure that identifies the execution context in which each execution simulation feature/activity/operation was observed. Generating the behavior vector in this manner also allows the system to aggregate information (e.g., frequency or rate) over time.

In various implementations, the behavior analyzer module 224 may be configured to generate the behavior vectors to include a concise definition of the observed behaviors of the simulated shell command execution. The behavior vector may succinctly describe an observed behavior of the simulated shell command execution, computing device, software application, or process in a value or vector data-structure (e.g., in the form of a string of numbers, etc.). Each value may be a discrete representation of a behavior. Similarly, simulated shell command execution behaviors may also be described by weighted values for behaviors are more easily expressed along a continuum. For example, the number of recently executed shell commands may be a base value indicating that that may be weighted by a multiplier indicating the length of time since the last execution (e.g., “0.1”=1 minute or less . . . “0.8”=eight minutes or more). In this way, behaviors may be described in a variety of terms, as best suited to the behavior characteristics.

The behavior vector may also function as an identifier that enables the computing device system to quickly recognize, identify, and/or analyze simulated shell command execution behaviors. In the various implementations, the observer and/or analyzer modules may be configured to generate the behavior vectors to include series of numbers, each of which signifies a feature or a behavior of the simulated shell command execution.

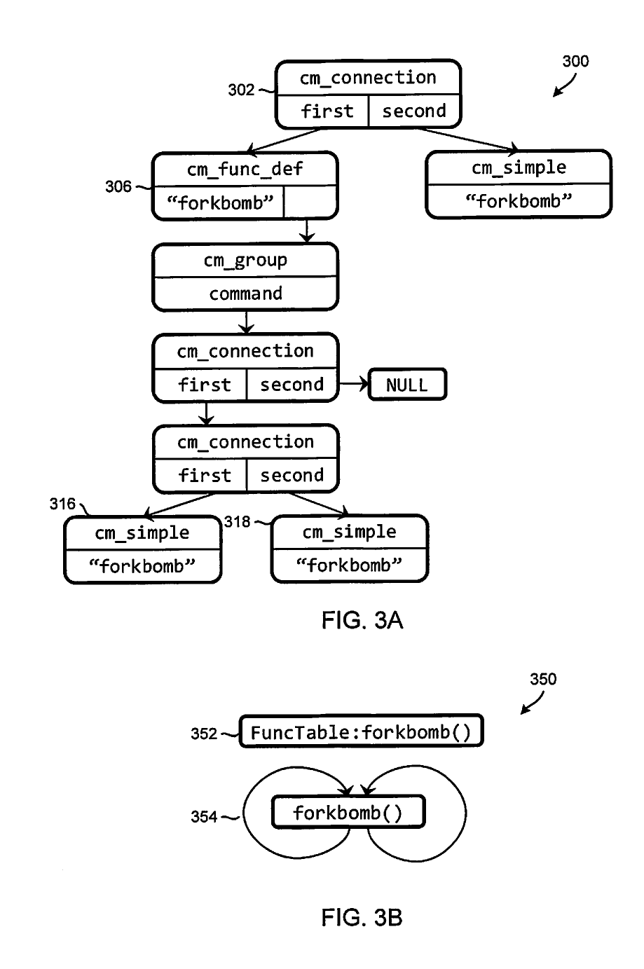

FIGS. 3A and 3B illustrate data structures suitable for use in detecting malicious shell commands using machine learning techniques to determine execution context of a shell command. The various implementations and embodiments may be carried out using computing devices and device processors (e.g. SOC 100, computing device 600).

Various implementations may perform a simulation of a shell command requested for execution by a software application. The processor of the computing device may observe shell command execution impact patterns throughout the simulation. Path analysis techniques may be used to identify security and privacy risks that could arise if the shell command is allowed to fully execute as requested. Path analysis techniques may be used to predict behavior of the command line functions by constructing specialized data structures: a parse graph 300, and an execution graph 350.

The parse graph 300 may be a tree data structure corresponding to a predicted execution path of the shell command. The parse graph 300 illustrates an example parse graph associated with the simulation of a “forkbomb” shell command. Upon initial execution (i.e., block 302), a single execution of a forkbomb may be carried out in block 304. However, because the command continues forking, it may continued indefinitely, such as in blocks 316 and 318 in which the forkbomb command is once again carried out. Features may be extracted from the parse graph 300, such as the length of commands, command arguments, and the number of special characters in command operators.

The execution graph 350 may be a tree structure, data table, linked list, etc. and may store information about the pattern and nature of the simulated shell command execution. For example, the execution graph 350 illustrates an entry 352 for the forkbomb command and a corresponding reference to forkbomb execution patterns in block 354.

In block 354, the recursive execution property of the forkbomb may be determined based on an analysis of the parse graph 300. Some or all of the information contained in the execution graph may be determined based, at least in part, on the information provided within the parse graph 300. For example, by analyzing the parse graph 300, the processor of the computing device may recognize that each iteration of the forkbomb command produces two additional iterations, calling the forkbomb command, and thus creating a recursive infinite process. Features may be extracted from the execution graph, such as existence of cyclical execution patterns and length of a defined function. Sink commands are those commands that direct or divert output to specified functions or connections. Given a set of sensitive source and sensitive sinks (assuming these are inputs or configurable parameters), the parse graph may enable the processor to identify paths that have connections with either any sensitive sources or sinks. Such paths (potentially partial paths) may be used to detect end-to-end malicious activities occurring throughout an application execution including application initiated shell commands. These features may be combined to form a set of extrapolated execution behavior information that may be used in the predictive analysis of shell command behavior.

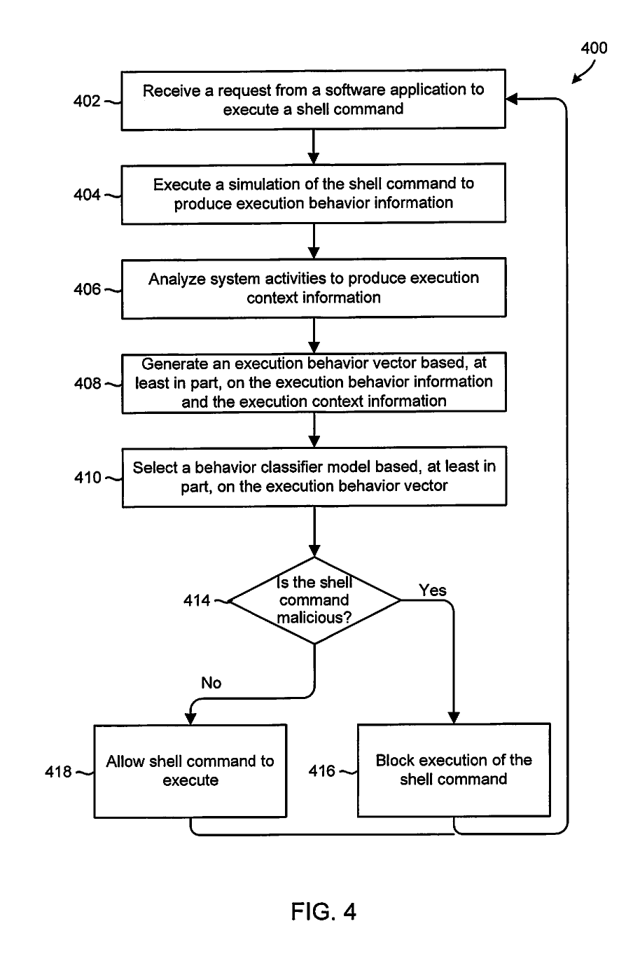

FIG. 4 illustrates a method 400 for detecting malicious shell commands using machine learning techniques to determine execution context of a shell command according to various embodiments. The method 400 may be carried out using computing devices and device processors (e.g. SOC 100, computing device 600). The computing device may apply machine learning techniques to collected behavior information associated with system activities relevant to the simulated execution of a shell command in order to determine the context in which the shell command might execute.

In block 402, the processor of the computing device (e.g., SOC 100, computing device 600) may receive a request from a software application to execute a shell command on the computing device. The software application may be currently executing or attempting to execute on the computing device. If the software application requires action by the computing device operating system, the software application may request execution of one or more shell commands. Such requests may be a part of normal software application operations; however, the computing device may perform predictive analysis to ensure that executing shell commands do not subvert authorized operating system functions.

In block 404, the processor of the computing device (e.g., SOC 100, computing device 600) may execute a simulation of executing the shell command to produce execution behavior information. As discussed with reference to FIGS. 3A and 3B, the processor may execute a simulation or emulation of the shell command execution in order to predict the outcome of allowing the shell command to execute as requested. Such emulation or simulation occurs while the shell command is queued, and prior to actual execution, thereby enabling the processor to block or limit execution of shell commands determined to be malicious. During the simulation process, the processor may generate specialized data structures (i.e., a parse graph 300, execution graph 350, etc.) from which the processor may extract behavior information. Further, the processor may analyze the specialized data structures to identify patterns, data leaks, and other information. This information may be combined to form a set of execution behavior information.

In block 406, the processor of the computing device (e.g., SOC 100, computing device 600) may analyze system activities to produce execution context information. The processor may collect and analyze data regarding the run-time conditions, including an execution context, of the shell command and the device. The execution context of the shell command simulation may include the previous N shell commands (where “N” is a positive integer), runtime information (e.g., API calls for “source” of some sensitive information), whether the current shell command is a “sink” command, Java API calls, shell environments, etc. The collected and analyzed information may be combined to form a set of execution context information.

In block 408, the processor of the computing device (e.g., SOC 100, computing device 600) may generate an execution behavior vector based, at least in part, on the execution behavior information and the execution context information. The processor may combine the execution context information and the execution behavior information into a behavior vector. The behavior vector, or execution behavior vector, may be a numerical representation of the feature elements of the information sets.

In block 410, the processor of the computing device (e.g., SOC 100, computing device 600) may select a behavior classifier model based, at least in part, on the execution behavior vector. A command-specific or application-specific classifier model may be selected from a bank of classifier models stored in a memory of the computing device. For example, the classifier model may be specific to “forkbomb” or recursive shell commands in general, or may be particular to a category of shell commands.

In determination block 414, the processor of the computing device (e.g., SOC 100, computing device 600) may use the selected behavior classifier model to determine whether the shell command is malicious. In various implementations, the processor may compare the selected behavior classifier model with the execution behavior vector. The result of the comparison may be a numerical figure or percentage of similarity. If the result of the comparison exceeds a threshold or indicates an unacceptable similarity/lack of similarity between the behavior classifier model and the execution behavior model, the processor may determine that the shell command behavior is malicious. Thus, the processor of the computing device may make predictive determinations regarding the malicious nature of shell commands prior to actual execution of the command.

In response to determining that the shell command is malicious (i.e., block 414=“Yes”), the processor of the computing device (e.g., SOC 100, computing device 600) may block execution of the shell command in block 416. That is the shell command may be execute in a limited capacity or prevented from executing at all. The processor may remove shell command from an execution stack to prevent execution. In some implementations an error message or notification may be displayed alerting the user that suspicious, malicious, or otherwise performance-degrading behavior was identified and thwarted.

In response to determining that the shell command is benign (i.e., block 414=“No”), the processor of the computing device (e.g., SOC 100, computing device 600) may allow the shell command to execute according to normal operations in block 418.

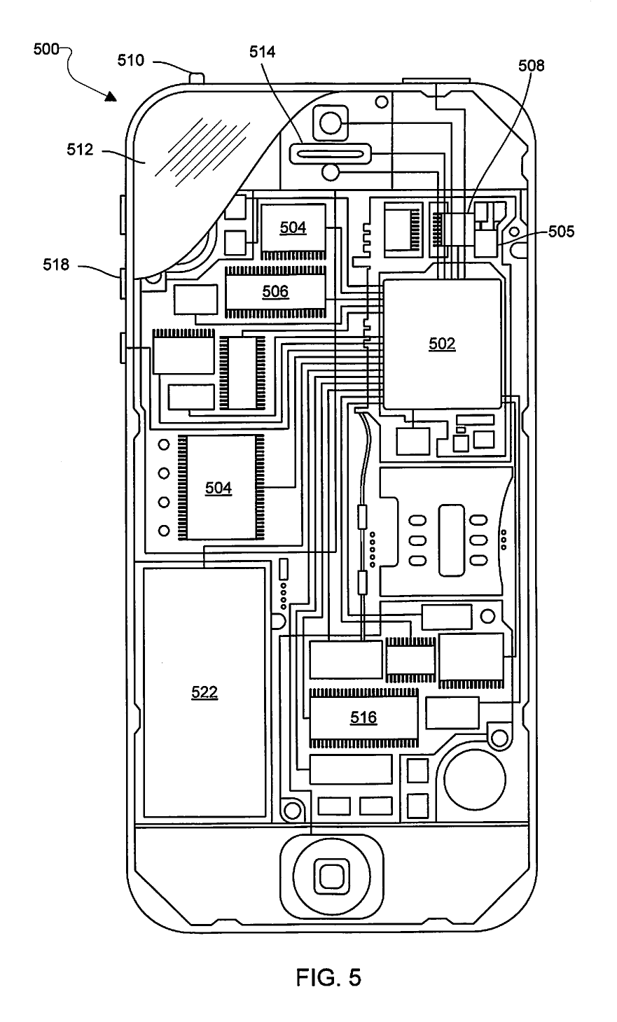

The various implementations may be implemented on a variety of mobile computing devices, an example of which is illustrated in FIG. 5 in the form of a smartphone 500. The smartphone 500 may include a processor 502 coupled to a touchscreen controller 504 and an internal memory 506. The processor 502 may be one or more multicore ICs designated for general or specific processing tasks. The internal memory 506 may be volatile or non-volatile memory, and may also be secure and/or encrypted memory, or unsecure and/or unencrypted memory, or any combination thereof. The touchscreen controller 504 and the processor 502 may also be coupled to a touchscreen panel 512, such as a resistive-sensing touchscreen, capacitive-sensing touchscreen, infrared sensing touchscreen, etc.

The smartphone 500 may have one or more radio signal transceivers 508 (e.g., Peanut®, Bluetooth®, Zigbee®, Wi-Fi, radio frequency radio) and antennae 510, for sending and receiving, coupled to each other and/or to the processor 502. The transceivers 508 and antennae 510 may be used with the above-mentioned circuitry to implement the various wireless transmission protocol stacks and interfaces. The processor 502 of the multicore device 500 may be coupled to a cellular network wireless modem chip 516 that enables communications via a cellular network. Smartphones 500 typically also include a speaker 514 and menu selection buttons or rocker switches 518 for receiving user inputs.

A typical smartphone 500 also includes a sound encoding/decoding (CODEC) circuit 522, which digitizes sound received from a microphone into data packets suitable for wireless transmission and decodes received sound data packets to generate analog signals that are provided to the speaker to generate sound. In addition, one or more of the processor 502, wireless transceiver 505, and CODEC 522 may include a digital signal processor (DSP) circuit (not shown separately).

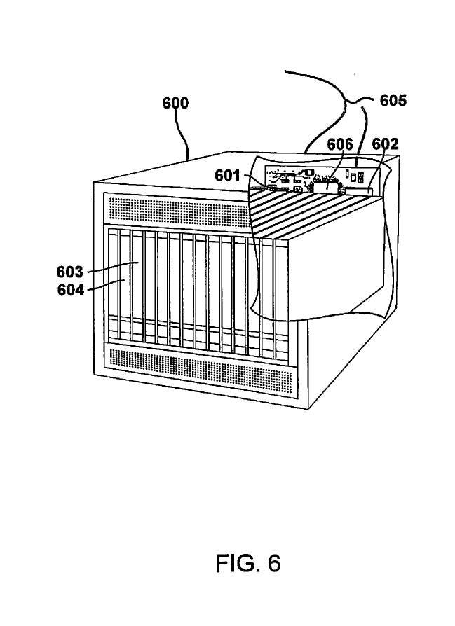

Portions of the implementation methods may be accomplished in a client-server architecture with some of the processing occurring in a server, such as maintaining databases of normal operational behaviors, which may be accessed by a computing device processor while executing the implementation methods. Such implementations may be implemented on any of a variety of commercially available server devices, such as the server 600 illustrated in FIG. 6. Such a server 600 typically includes a processor 601 coupled to volatile memory 602 and a large capacity nonvolatile memory, such as a disk drive 603. The server 600 may also include a floppy disc drive, compact disc (CD) or digital versatile disc (DVD) disc drive 604 coupled to the processor 601. The server 600 may also include network access ports 606 coupled to the processor 601 for establishing data connections with a network 605, such as a local area network coupled to other broadcast system computers and servers.

The processors 502, 601 may be any programmable microprocessor, microcomputer or multiple processor chip or chips that can be configured by software instructions (applications) to perform a variety of functions, including the functions of the various implementations described below. In some computing devices, multiple processors 502 may be provided, such as one processor dedicated to wireless communication functions and one processor dedicated to running other applications. Typically, software applications may be stored in the internal memory 506, 602, 603 before they are accessed and loaded into the processor 502, 601. The processor 502, 601 may include internal memory sufficient to store the application software instructions.

The term “performance degradation” is used in this application to refer to a wide variety of undesirable computing device operations and characteristics, such as longer processing times, slower real time responsiveness, lower battery life, loss of private data, malicious economic activity (e.g., sending unauthorized premium SMS message), denial of service (DoS), operations relating to commandeering the computing device or utilizing the phone for spying or botnet activities, etc.

Generally, a behavior vector may be a one-dimensional array, an n-dimensional array of numerical features, an ordered list of events, a feature vector, a numerical representation of one or more objects, conditions or events, an execution context machine, etc. In an implementation, the behavior vector may include one or more behaviors. In various implementations, a behavior may be represented as a number value or a structure that stores number values (e.g., vector, list, array, etc.).

Computer program code or “code” for execution on a programmable processor for carrying out operations of the various embodiments may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used herein refer to machine language code (such as object code) whose format is understandable by a processor.

Computing devices may include an operating system kernel that is organized into a user space (where non-privileged code runs) and a kernel space (where privileged code runs). This separation is of particular importance in Android® and other general public license (GPL) environments where code that is part of the kernel space must be GPL licensed, while code running in the user-space may not be GPL licensed. It should be understood that the various software components discussed in this application may be implemented in either the kernel space or the user space, unless expressly execution context otherwise.

As used in this application, the terms “component,” “module,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core, and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

The foregoing method descriptions and the process flow diagrams are provided merely as illustrative examples and are not intended to require or imply that the blocks of the various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or execution context machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product The preceding description of the disclosed embodiments is provided to enable any person skilled in the art to make or use the claims.

Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of detecting malicious shell commands prior to execution on a computing device, the method comprising:
receiving, by a processor of the computing device, a request from a software application to execute a shell command on the computing device;
simulating execution of the shell command to produce execution behavior information;
analyzing system activities to produce execution context information;
generating an execution behavior vector based, at least in part, on the execution behavior information and the execution context information;
using a behavior classifier model to determine whether the shell command is malicious; and
blocking execution of the shell command in response to determining that the shell command is malicious.

2. The method of claim 1, further comprising selecting the behavior classifier model based, at least in part, on the execution behavior vector comprises selecting a command specific classifier model.

3. The method of claim 2, wherein selecting the behavior classifier model comprises selecting a command specific classifier model.

4. The method of claim 2, wherein selecting the behavior classifier model comprises:
identifying execution characteristics of the simulated shell command execution; and
selecting the behavior classifier model to include the identified characteristics.

5. The method of claim 1, wherein simulating execution of the shell command to produce execution behavior information comprises:
predicting an execution path of the shell command; and
analyzing behaviors of the predicted execution path to identify the execution behavior information.

6. The method of claim 5, wherein predicting the execution path of the shell command comprises generating a parse data structure.

7. The method of claim 5, wherein analyzing the behaviors of the predicted execution path to identify the execution behavior information comprises characterizing patterns of commands executed within the predicted execution path.

8. The method of claim 5, wherein analyzing the behaviors of the predicted execution path to identify the execution behavior information comprises identifying data leaks resulting from commands executed within the predicted execution path.

9. The method of claim 1, wherein analyzing system activities includes analyzing a number of preceding shell commands.

10. The method of claim 1, wherein analyzing system activities includes analyzing application program interface calls.

11. The method of claim 1, wherein analyzing system activities include determining whether the shell command is a sink command.

12. The method of claim 1, wherein analyzing system activities include determining a shell environment.

13. A computing device, comprising:
a processor configured to:
receive a request from a software application to execute a shell command on the computing device;
simulate execution of the shell command to produce execution behavior information;
analyze system activities to produce execution context information;
generate an execution behavior vector based, at least in part, on the execution behavior information and the execution context information;
use a behavior classifier model to determine whether the shell command is malicious; and
block execution of the shell command in response to determining that the shell command is malicious.

14. The computing device of claim 13, wherein the processor is further configured to select the behavior classifier model based, at least in part, on the execution behavior vector comprises selecting a command specific classifier model.

15. The computing device of claim 14, wherein the processor is further configured to select the behavior classifier model by selecting a command specific classifier model.

16. The computing device of claim 14, wherein the processor is further configured to select the behavior classifier model by:
identifying execution characteristics of the simulated shell command execution; and
selecting the behavior classifier model to include the identified characteristics.

17. The computing device of claim 13, wherein the processor is further configured to simulate execution of the shell command to produce execution behavior information by:
predicting an execution path of the shell command; and
analyzing behaviors of the predicted execution path to identify the execution behavior information.

18. The computing device of claim 17, wherein the processor is further configured to predict the execution path of the shell command by generating a parse data structure.

19. The computing device of claim 17, wherein the processor is further configured to analyze the behaviors of the predicted execution path to identify the execution behavior information by characterizing patterns of commands executed within the predicted execution path.

20. The computing device of claim 17, wherein the processor is further configured to analyze the behaviors of the predicted execution path to identify the execution behavior information by identifying data leaks resulting from commands executed within the predicted execution path.

21. The computing device of claim 13, wherein the processor is further configured to analyze system activities by analyzing a number of preceding shell commands.

22. The computing device of claim 13, wherein the processor is further configured to analyze system activities by analyzing application program interface calls.

23. The computing device of claim 13, wherein the processor is further configured to analyze system activities by determining whether the shell command is a sink command.

24. The computing device of claim 13, wherein the processor is further configured to analyze system activities include determining a shell environment.

25. A non-transitory computer-readable medium, having stored thereon processor-executable instructions configured to cause a processor of a computing device to perform operations comprising:
receiving a request from a software application to execute a shell command on the computing device;
simulating execution of the shell command to produce execution behavior information;
analyzing system activities to produce execution context information;
generating an execution behavior vector based, at least in part, on the execution behavior information and the execution context information;
using a behavior classifier model to determine whether the shell command is malicious; and
blocking execution of the shell command in response to determining that the shell command is malicious.

26. The non-transitory computer-readable medium of claim 25, wherein the stored processor-executable instructions are configured to cause a processor of a computing device to perform operations further comprising selecting the behavior classifier model based, at least in part, on the execution behavior vector comprises selecting a command specific classifier model.

27. The non-transitory computer-readable medium of claim 26, wherein the stored processor-executable instructions are configured to cause a processor of a computing device to perform operations such that selecting the behavior classifier model comprises selecting a command specific classifier model.

28. The non-transitory computer-readable medium of claim 26, wherein the stored processor-executable instructions are configured to cause a processor of a computing device to perform operations such that selecting the behavior classifier model comprises:
identifying execution characteristics of the simulated shell command execution; and
selecting the behavior classifier model to include the identified characteristics.

29. The non-transitory computer-readable medium of claim 25, wherein the stored processor-executable instructions are configured to cause a processor of a computing device to perform operations such that simulating execution of the shell command to produce execution behavior information comprises:
predicting an execution path of the shell command; and
analyzing behaviors of the predicted execution path to identify the execution behavior information.

30. A computing device comprising:
means for receiving a request from a software application to execute a shell command on the computing device;
means for simulating execution of the shell command to produce execution behavior information;
means for analyzing system activities to produce execution context information;
means for generating an execution behavior vector based, at least in part, on the execution behavior information and the execution context information;
means for using a behavior classifier model to determine whether the shell command is malicious; and
means for blocking execution of the shell command in response to determining that the shell command is malicious.
